(19) United States
(12) Patent Application Publication
(10) Pub. No.: US 2003/0197606 A1
(43) Pub. Date: Oct. 23, 2003

(54) Vehicle rear light warning system

(76) Inventor: Aaron Epstein, San Jose, CA (US)

Correspondence Address: Richard A. Ryan, RYAN & ENGNATH, Suite 104, 8469 N. Millbrook, Fresno, CA, 93720, US

(21) Appl. No.: 10/126,909

(22) Filed: Apr. 22, 2002

(51) Int. Cl. B60Q 1/54

(52) U.S. Cl. 340/466

(57) ABSTRACT

A rear light warning system for vehicles to indicate to drivers of trailing vehicles that the leading vehicle is slowing down, moving slow or stopping to reduce the likelihood of rear-end collisions. The system has rearwardly illuminating warning lights attached to the rear of the vehicle, a speed sensor and an integrated circuit, all of which are independent of the brake or accelerator pedals. The speed sensor determines the relative speed of the vehicle and the integrated circuit compares the electrical signal with that for a predetermined minimum base speed level. If the vehicle is traveling at less than the base speed level, then the warning lights are activated. The speed sensor can determine the relative speed by measuring the rotation of the wheel, rotation of an inner cable in a mechanical speedometer cable, a signal from an electronic speedometer or sensing a reflective wavelength off the ground.

### BACKGROUND OF THE INVENTION

A. Field of the Invention

The field of the present invention relates generally to brake light warning systems for vehicles having a conventional braking system and rear brake lights, especially such systems that are adapted for warning a driver in a trailing vehicle of the slow speed or deceleration of a leading vehicle. More specifically, this invention relates to such systems that activate rear directed warning lights when the speed of a vehicle is within a certain range of speeds, as measured at the wheel or speedometer of the vehicle or movement of the vehicle relative to the ground.

B. Background

Most vehicles in use today utilize conventional brake light systems having rearward facing warning lights that are electrically connected to the operation of the brakes. Such brake light systems for vehicles typically provide one or more rear mounted lamps (brake lights) that illuminate a bright red color whenever the vehicle's brake pedal is depressed by the driver. The activation of the brake lights is usually achieved through the use of sensors connected to the operation of the brake pedal. When the driver's foot is removed from the brake pedal the brake lights are deactivated (i.e., turn off). Due to the rearward facing direction of these lights, they are primarily used to warn a vehicle that is behind (the “trailing vehicle”) a forward vehicle (the “leading vehicle”) that is braking. To improve the effectiveness of brake lights as a warning device for trailing vehicles, newer vehicles are required to have an additional brake light located at an elevated level so that the warning light may be provided closer to the eye level of the driver of a trailing vehicle. Typically, the elevated warning light is centered on a rear deck or above the rear window of vehicles. Despite this improvement to rear braking light systems, rear end collisions continue to occur with substantial frequency, indicating that there is room for further improvement.

One significant limitation of prior art brake light systems is their failure to address a common hazardous situation that results when a leading vehicle is traveling slow or is momentarily in a slowed condition relative to the speed of a trailing vehicle. It is well known that drivers will slow their vehicle down when approaching a road obstruction or due to poor visibility, people or animals in the road or for a variety of other reasons. Often, the deceleration and continued slow speed of the vehicle is obtained and maintained without resort to the vehicle's brake pedal and braking system (such as when the driver of the leading vehicle takes his or her foot off the gas to decelerates) or, if the brake pedal was originally depressed to slow the vehicle down, the driver may have subsequently released the brake pedal in preparation for resuming normal driving speed. As a trailing vehicle approaches the slowed or slowing leading vehicle, the driver of the trailing vehicle may not realize that the speed of his or her vehicle is much less than the speed of the leading vehicle. Unfortunately, the trailing vehicle may be upon the leading vehicle before the driver of the trailing vehicle realizes he or she needs to decelerate or stop or, if they do realize that need, before he or she is able to slow the trailing vehicle down enough to effectuate a safe approach to the leading vehicle.

There are a number of commonly occurring circumstances where trailing vehicles may, inadvertently, too rapidly approach a slow moving or slowing leading vehicle. One such circumstance is when the trailing vehicle approaches a leading vehicle that was in a stopped condition (i.e., at a traffic light, stop sign or pulling away from the curb) and which is only beginning to accelerate back to normal driving speed. Another circumstance is when the leading vehicle slows down to round a corner onto another street, turn into a driveway, make a “U” turn or otherwise exit from the main road. Yet another such circumstance is when the leading vehicle slows down on the highway or street due to an obstruction in the road, poor visibility or the driver looking for landmarks and signs. In each of these and other such circumstances, the driver of the trailing vehicle may be unable to notice the difference in relative speeds before he or she is upon the leading vehicle, particularly if the difference in speed is accompanied by a lack of brake or other warning lights activated on the leading vehicle so as to indicate to the driver of the trailing vehicle the need to slow down as he or she approaches the leading vehicle. This can lead to a particularly dangerous situation if the normal vehicle speed of the road is somewhat high (i.e., 50 mph or more).

Even when the vehicle's brakes are used to control the speed of the vehicle, it is well known that vehicle brakes can be applied with varying degrees of force and, as a result, stopping power. When the brake lights of a leading vehicle are activated, the driver of a trailing vehicle cannot determine from the activation of the brake lights just how rapidly or slowly the leading vehicle is slowing down, or even if it is slowing down at all. For vehicle safety purposes, it would is best for the driver of the trailing vehicle to have some indication of the degree of braking force being applied by the driver of the leading vehicle so he or she can determine how rapidly the leading car is decelerating. For instance, if the leading vehicle is decelerating rapidly, the drive of the trailing vehicle needs to know that he or she should respond similarly, particularly if positioned close behind the leading vehicle. Conversely, if the leading vehicle is decelerating slowly, the driver of the trailing vehicle would be able to know that he or she can likewise decelerate slowly.

There have been a number of prior art devices or systems that have attempted to solve the problems identified above. One attempt to provide a more effective brake alert system is disclosed in U.S. Pat. No. 4,663,609 to Rosario, in which depression of a vehicle's brake pedal causes the brake lights to flash in a manner designed to attract attention of a driver in a trailing vehicle. This system, similar to others, provides an improved attention-getting signal but requires activation by the vehicle's brake pedal. Another brake light system is disclosed in U.S. Pat. No. 4,403,210 to Sullivan, wherein depression of the vehicle brake pedal causes the brake lights to flash on and off a predetermined number of times and, thereafter, to remain continuously illuminated until the brake pedal is released, or until the vehicle turn signal lever is moved left or right. This invention similarly fails to address the special hazards of the slowed vehicle because releasing the brake pedal turns off the brake lights and not stepping on the brake pedal fails to activate any lights. U.S. Pat. No. 4,224,598 to Ostrowski discloses a device that incorporates a signaling system that allows the trailing vehicle to know whether the driver in front is accelerating, coasting or braking. The system includes one switch that is activated by the accelerator of the vehicle and another switch that is connected to the brake pedal. Yet another device directed to a safety light warning system for vehicles is described in U.S. Pat. No. 4,470,036 to Doerr, et al. This device has three modes of operation, including a caution mode that operates only when either the gas or the brake pedal is pressed. Yet another vehicle brake warning light system is addressed in U.S. Pat. No. 3,911,394 to Shames, in which vehicle brake lights are operated for a given period of time in response to the lifting of the driver's foot from the accelerator pedal. While this system provides an early warning signal that the vehicle is slowing, it does not work effectively for a previously stopped or slowed vehicle that is in the process of gathering speed. U.S. Pat. No. 3,693,151 to Hasegawa et al. discloses a flashing brake lamp circuit that causes flashing of the brake lights while the brake pedal is depressed but not continuing the flashing function after the brake pedal is no longer depressed. None of the aforementioned prior art patents serve to effectively notify a trailing vehicle that the leading vehicle is slowing down without the use of the brake system (i.e., merely lifting the foot off the gas pedal) or that the leading vehicle is going slow while it is in the process of accelerating to the normal traffic speed.

What is needed is a vehicle rear light warning system that effectively warns a trailing vehicle that a leading vehicle is moving slowly, whether slowly being driven, accelerated or decelerated so that the trailing vehicle does not approach it at an excessive rate of speed. To be effective, the warning system should not be tied solely to the pressure placed on the brake and/or accelerator pedals. Preferably, an improved vehicle warning system should be configured to recognize stopping, slowing down and slow moving (i.e., while accelerating) conditions. The preferred system should also be relatively inexpensive to make, require no manipulation by the driver while driving and adaptable to installation in both new and existing vehicles. With use of such an improved vehicle warning system, the likelihood of rear end collisions may be greatly reduced, thereby reducing the costs, injuries and lost time associate with such motor vehicle accidents.

### SUMMARY OF THE INVENTION

The vehicle rear warning light system of the present invention provides the benefits and solves the problems identified above. That is to say, the present invention discloses a rear warning light system that automatically warns the driver of a trailing vehicle that a leading vehicle is moving slow or stopped so that the trailing vehicle driver can take appropriate action to avoid a rear-end collision. The warning system of the present invention measures the speed of the vehicle at the wheel or by reflecting a signal off the ground or by receiving speed information from the odometer system the speed of the vehicle to determine whether to illuminate one or more rearward facing lights to warn the driver of the trailing vehicle that the leading vehicle is moving slow or stopped. As set forth in more detail below, the warning system of the present invention is adaptable to both new and existing vehicles, is relatively inexpensive to manufacture and install in a vehicle and is not tied solely to the operation of the brake and/or accelerator pedals. The vehicle rear light warning system described and claimed herein will reduce the number and severity of rear-end collisions so as to reduce the costs, injuries and deaths associated with such accidents.

The vehicle rear light warning system of the present invention generally comprises one or more warning lights, sensor mechanism and an integrated circuit. The warning lights are fixedly attached to the rear side of a vehicle and configured to be generally rearwardly illuminating so that a trailing vehicle can clearly see the warning lights. The sensor mechanism should attach to the vehicle and be suitable for sensing the speed of the vehicle in a manner that is independent of the vehicle's brake and acceleration pedals. The integrated circuit is configured for calculating or determining the speed of the vehicle relative to a predetermined base speed level and for activating the warning lights when the speed of the vehicle is below the predetermined base speed level. Typically this will be accomplished by utilizing a voltage comparator in or connected to the integrated circuit. Generally, the system will be operatively connected to the vehicle's battery to provide power to the integrated circuit and warning lights. In the preferred embodiment, the system is also electrically connected to an ignition switch on the vehicle such that it is only activated when the ignition switch is in an on or run condition.

In one embodiment, the vehicle rear sensor mechanism is of the type that measures the speed of the vehicle by sensing the rotation of a wheel on the vehicle. To accomplish this, the sensor mechanism can utilize one or more magnets fixedly attached to one of the vehicle's wheels with a magnetic sensor coil attached to a stationary part of the vehicle near the wheel. The magnet and the magnetic sensor coil operatively must be positioned so that they work together to generate an electrical signal as a result of the rotational movement of the magnet past the sensor coil. The electronic signal should be suitable for the integrated circuit to determine the speed of the vehicle relative to the predetermined base speed level.

In another embodiment, the sensor mechanism measures the speed of the vehicle by sensing the rotational speed of a rotating inner cable of the vehicle's speedometer cable. This can be accomplished by placing one or more magnetic strips on the inner cable and a magnetic sensor coil operatively displaced from the speedometer cable so that it generates an electrical signal suitable for the integrated circuit to determine the speed of the vehicle relative to the predetermined base speed level. In yet another embodiment of the sensor mechanism, the sensor mechanism can be operatively connected to an electronic speedometer in the vehicle and an electronic circuit can be attached to the speedometer. In yet another embodiment of the sensor mechanism, the sensor mechanism can be a combination reflective wave length transmitter and receiver that is operatively connected to an electronic circuit controlling warning light activation.

Other alternative embodiments include the use of manually or mechanically removable lens on the warning lights, either by taking the lens off or utilizing hingedly attached lens that can be flipped up out of the way. One or more stop lights can be fixedly attached to the rear side of the vehicle such that they are configured to be generally rearwardly illuminating. The stop lights should be operatively connected to the integrated circuit so that the circuit will activate the stop lights when the vehicle stops moving. Preferably, the stop lights are positioned next to the warning lights or the warning lights are positioned on vehicle high above the stop lights.

Accordingly, the primary objective of the present invention is to provide a rear light warning system for vehicles that effectively warns the driver of a trailing vehicle that the vehicle equipped with such system is slowing down, stopping or moving slowly.

It is also an important objective of the present invention to provide a vehicle rear light warning system having one or more rearwardly illuminating warning lights that are illuminated when the vehicle is slowed down, moving slowly, stopped or moving slowly as it begins to accelerate to normal traffic speed from a stopped or slow speed condition.

It is also an important objective of the present invention to provide a vehicle rear light warning system that detects or analyzes the speed of the vehicle to determine whether safety lights should be illuminated so as to warn persons in trailing vehicles that the leading vehicle is moving slowly or is stopped to prevent or reduce the number and severity of rear-end collisions.

It is also an important objective of the present invention to provide a vehicle rear light warning system that calculates the speed of a vehicle by measuring the rotations of one of the vehicle's wheels or other circular moving parts related to rotational speed so as to determine whether to illuminate one or more rearward facing lights to warn trailing vehicles that the leading vehicle is slowing down, moving slowly or stopped.

It is also an important objective of the present invention to provide a vehicle rear light warning system that is activated by a circuit sensing a wavelength (i.e., be it infrared or sound wave) reflection.

It is also an important objective of the present invention to provide a vehicle rear light warning system that is electrically connected to the vehicle's speedometer so as to determine whether to illuminate one or more rearward facing lights to warn trailing vehicles that the leading vehicle is slowing down, moving slowly or stopped.

It is also an important objective of the present invention to provide a vehicle rear light warning system as described herein that is adaptable to both new and existing vehicles.

It is also an objective of the present invention to provide a vehicle rear light warning system as described herein that is automatically activated when the vehicle is moving slow or is stopped, relatively inexpensive to manufacture and install and adaptable to all types of vehicles.

The above and other objectives of the present invention will be explained in greater detail by reference to the attached figures and the description of the preferred embodiment which follows. As set forth herein, the present invention resides in the novel features of form, construction, mode of operation and combination of parts presently described and understood by the claims.

### BRIEF DESCRIPTION OF THE DRAWINGS

In the drawings which illustrate the best modes presently contemplated for carrying out the present invention:

FIG. 1 is a schematic of a preferred embodiment of the system of the present invention;

FIG. 2 is a rear view of a vehicle incorporating the rear light warning system of the present invention;

FIG. 3 is a cross-section of the tire assembly showing the rear light warning system of the present invention;

FIG. 4 is an electrical schematic of an embodiment of the rear light warning system of the present invention utilizing the rotation the vehicle's wheel;

FIG. 5 is an illustration of an embodiment of the rear light warning system of the present invention utilizing a vehicle's mechanically operated speedometer;

FIG. 6 is an illustration of an embodiment of the rear light warning system of the present invention utilizing a vehicle's electronic speedometer; and

FIG. 7 is an illustration of the embodiment of the rear light warning system that utilizes rearwardly illuminating stop lights.

FIG. 8 is an illustration of the embodiment of the rear light warning system that utilizes a sensor which detects a pulsed reflected wavelength (i.e., infrared, radar, sound wave or light reflection) off of the ground.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are illustrative of the preferred embodiments and represent a preferred way of configuring the present invention. Although specific components, materials, configurations and uses are illustrated, it should be understood that a number of variations to the components and to the configuration of those components described herein and in the accompanying figures can be made without changing the scope and function of the invention set forth herein.

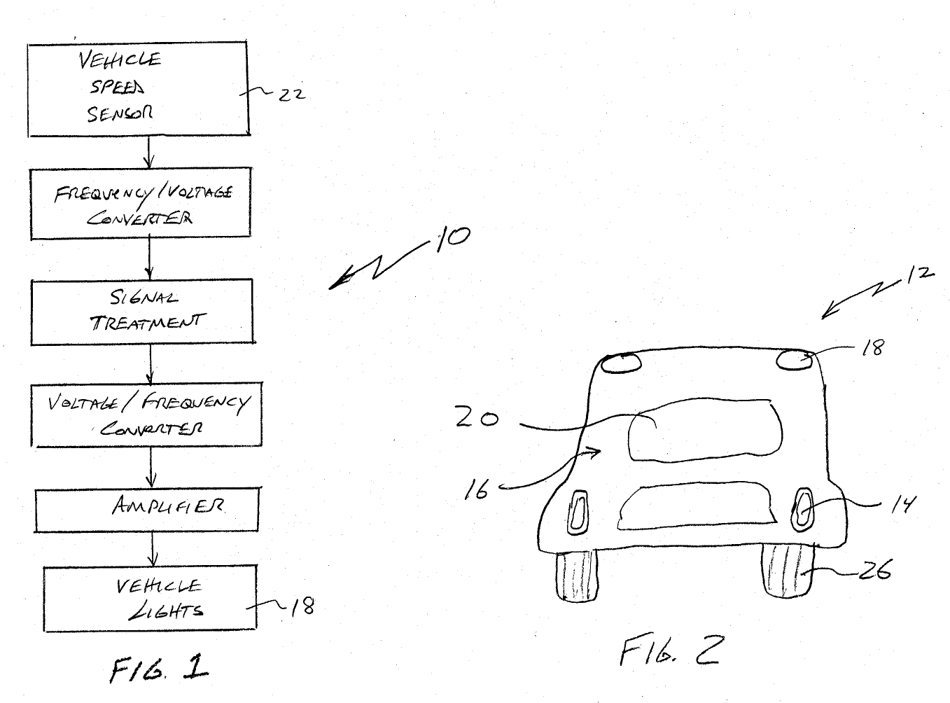

A general schematic of a vehicle rear light warning system of the present invention is shown generally as 10 in FIG. 1. As best shown in FIG. 2, the warning system 10 of the present invention will be used with vehicles, typically motor vehicles such as a truck, farm tractor or automobile 12, which are currently equipped with one or more rearward illuminating taillights 14 at the rear 16 of the vehicle 12. As is commonly known and utilized, taillights 14 are illuminated at night by the driver's manual operation of a light switch located in the driver's compartment and are usually red in color. In the typically utilized brake light warning system, when the driver of the vehicle 12 places pressure on the vehicle's brake pedal the taillights 14 will be brightly illuminated, relative to the normal brightness of taillights 14, to indicated that the brake pedal is being depressed. As soon as the driver of vehicle 12 removes his or her foot (pressure) from the brake pedal, the brightly lit portion will turn off and the taillights 14 will return to the normal lighting condition. During the daytime, when the front and rear lights are typically not used, the driver's pressure on the brake pedal will cause the taillights 14 to brightly light up. When the pressure is removed from the brake pedal, the taillights 14 return to their normally off condition. Some vehicles have either separate rearwardly facing lights for the brake light and rear light indicators or have separate portions of the same taillight for braking and rearward illumination.

Although the rear light warning system 10 of the present invention can be incorporated into a vehicle's pre-existing taillights 14, the preferred embodiment utilizes one or more separate warning lights, shown as 18 in FIG. 2. The warning lights 18 should be placed at the rear 16 of vehicle 12 in a rearward facing position so that when they are illuminated they can be clearly seen by the driver of a tailing vehicle. Preferably, the system 10 comprises one or more warning lights 18 placed at or slightly above the typical eye level of a tailing vehicle, such as near the top of the sides of the rear 16 of vehicle 12 as shown in FIG. 2, or at or near the rear window 20 of vehicle 12 (where many vehicles currently have one or more braking lights). In the embodiment shown in FIG. 2, the system 10 utilizes a pair of lights 18. Because the standard taillights 14 are red in color, as mandated by governmental agencies, it is preferred that the warning lights 18 of the system 10 of the present invention be a different color, such as amber or other shades of yellow. The use of a different color, particularly one that is already associated with warning or caution signals in driving (i.e., yellow), than the illuminated color of taillights 14 will improve the effectiveness of the warning system 10 by making drivers more aware of the conditions that exist with the leading vehicle 12 (as set forth below).

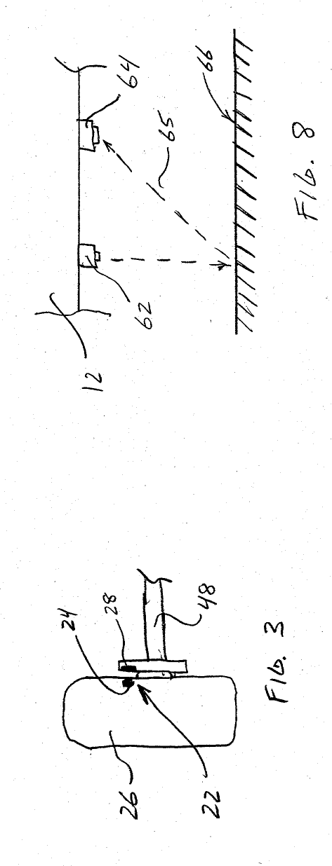

As illustrated in FIGS. 1 through 4, the warning system 10 generally comprises a vehicle speed sensor device 22 for sensing the speed of vehicle 12 so as to determine the need to illuminate warning lights 18. As set forth in more detail below, various devices 22 that are independent of the vehicle's brake and acceleration pedals can be used with the present invention 10 to sense the speed of vehicle 12. Once the speed of vehicle 12 is sensed, an electrical signal is transmitted to a frequency/voltage converter and then to a device for signal treatment, such as an integrated circuit, that compares the measured speed of the vehicle 12 to a preset vehicle speed level. If the vehicle's speed is below this preset value (referred to hereinafter as the “base speed level”), then an electrical signal will be sent and then amplified so as to illuminate warning lights 18. The base level will be some standard level, for instance 25 mph, that can be set by a highway safety organization or governmental agency based on a determination that vehicles above the base speed level do not typically have a problem with the trailing vehicle colliding with the leading vehicle.

One vehicle speed sensor device 22 that can be used with the warning system 10 of the present invention is the use of a magnet 24 fixedly attached to a wheel 26 of vehicle 12 in close proximity (i.e., approximately 1/16 to ½ of an inch spacing) to a stationary magnetic sensor coil 28 fixedly attached to a stationary part of the vehicle 12 such that when wheel 26 rotates it causes magnet 24 to pass by sensor coil 28 to generate current. Alternatively, but not preferred, the speed sensor device 22 can utilize the sensor coil 28 attached on the rotating wheel 26 and the stationary magnet 24 attached to the stationary part of the vehicle 12. The actual spacing between magnet 24 and sensor coil 28 will be dependant on the strength of magnet 24 and the sensitivity of coil 28. While the magnet is attached to a rotating portion of wheel 26, the sensor coil will be attached on a fixed, non-moving portion of the wheel housing and will be suspended in air. An electrical schematic of one preferred embodiment of the present invention 10 is set forth in FIG. 4. As shown therein, the warning system 10 can comprise one or more voltage comparators 30, a transistor 32, an integrated circuit 34, voltage regulator 36 and various resistors, capacitors, relays and diodes, as are known in the industry to be needed or useful, to transmit the electrical signal generated at vehicle speed sensor device 22 for comparison to the base speed level and, if needed, to illuminate warning lights 18. The system 10 shown in FIG. 4, is powered by the vehicle's battery 38. Alternatively, a separate, system specific source of power could be used. Preferably, the system 10 is electrically connected to the ignition switch 40 so that it only operates when vehicle 12 is being operated (i.e., when the key is in the ignition and the switch 40 is turned to the run position). Connection to the ignition switch 40 avoids problems with the lights 18 being on when the key is in the ignition switch 40 but in other than the “run” position of vehicle 12.

In use, the magnet 24 is fixedly attached to the inside portion of wheel 26 that rotates with wheel 26 and the magnetic sensor coil 28 is attached to a fixed portion of the vehicle 12 such that as wheel 26 rotates, magnet 24 passes by the position of the sensor coil 28 to generate electrical current. The electrical current is transmitted to a voltage comparator 30 which compares it to a pre-set voltage level that is equivalent to the base speed level, such as 25 mph. When the vehicle 12 ignition switch is turned to the run position, the warning system 10 will determine that the speed of the vehicle 12 is zero and, because it is less than the base speed level, will activate the warning lights 18. In the preferred embodiment, the warning lights 18 will flash to warn vehicles positioned behind vehicle 12 that it is not moving. As vehicle 12 begins to gain speed, the system 10 will continuously monitor the speed of the vehicle 12 and compare it to the base speed level. As long as the speed of the vehicle 12 is less than the base speed level, the warning lights 18 will flash. When the speed of the vehicle 12 exceeds the base speed level, system 10 will deactivate the warning lights 18. Although warning lights 18 are off, the system 10 will continue to determine and compare the speed of the vehicle 12 to the base speed level. As soon as the speed of vehicle 12 drops below the base speed level (i.e., when the vehicle 12 slows down to stop, make a turn or due to visibility or traffic conditions), the system 10 will again activate the warning lights 18 until the speed of vehicle 12 once again exceeds the base speed level or the vehicle's ignition key is turned off or away from the “run” position.

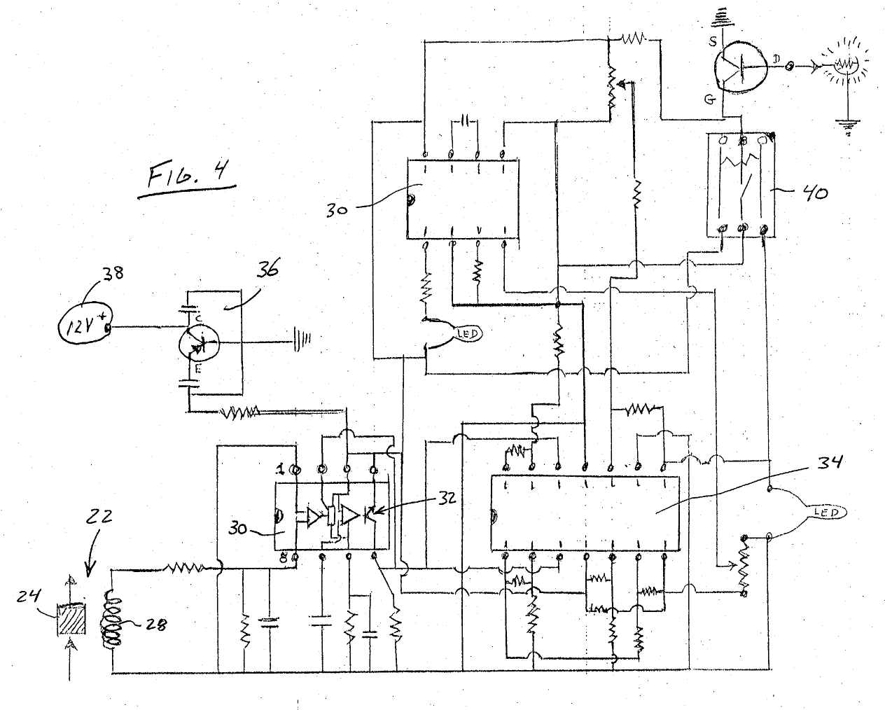

An alternative speed sensor 22 for use with the rear light warning system 10 of the present invention utilizes the vehicle's speedometer cable 42, as shown in FIG. 5, having a rotating inner cable 44 and an outer protective sheath 46. As is well known in the art, inner cable 44 is connected at one end to the vehicle 12 (i.e., at the axle 48) and is connected at the other end to a mechanical speedometer 50 in the driver's compartment of vehicle 12. The inner cable 44 rotates at a speed that is proportional to the speed of the vehicle 12 to operate the speedometer 50 so as to indicate to the driver the speed of vehicle 12. In this embodiment, one or more magnetic strips 52 are attached to the rotating inner cable 44 so as to rotate with cable 44 at a rotational speed that is also proportional to the speed of vehicle 12. Positioned close to and aligned with magnetic strips 52 is a magnetic sensor coil 28 that generates electrical current as a result of the interaction between the rotating magnet strips 52 and sensor coil 28. The electrical current is transmitted through system 10 to activate the warning lights 18 when the ignition switch 40 is turned to run and the speed of vehicle 12 is below the base speed level, and deactivate the warning lights 18 when the speed of vehicle 12 rises above the base speed level or the ignition switch 40 is turned to the off position (as described in more detail above). In use, the vehicle's standard speedometer cable 42 is replaced with an speedometer cable 42 having an inner cable 44 with one or more magnetic strips 52 on the inner cable 44 or, alternatively, just the inner cable 44 is replaced with an inner cable having magnetic strips 52 thereon, or the magnetic strips 52 are added to the vehicle's existing inner cable 44. A sensor coil 28 is added to the vehicle 12 in close proximity to the speedometer cable 42 and in alignment with the magnetic strips 52. The rotating speed of the cable is converted to an electrical signal that is relative to the speed of vehicle 12. The remaining electrical components of system 10 are configured to operate with the vehicle 12 and warning lights 18 as described above to provide a visual warning to persons driving vehicles behind vehicle 12 that vehicle 12 is slowing down, moving slow or preparing to stop.

Another alternative speed sensor 22, shown in FIG. 6, for use with the rear light warning system 10 of the present invention utilizes an electronic speedometer 54 that is available or in use in a number of vehicles. In this embodiment, an additional circuit, illustrated as 56, is added to the electronic speedometer 54 and connected to the warning lights such that when the circuit 56 determines that speedometer 54 is reading a speed less than the base speed level it will activate warning lights 18 to signal to persons driving vehicles behind vehicle 12 that vehicle 12 is slowing down, moving slow or preparing to stop. As above, circuit 56 should be operatively connected to the ignition switch 40 so that it will only operate when the key is turned to the “run” position.

Yet another speed sensor 22 that could be used with the rear light warning system 10 of the present invention is a laser ground speed indicator for sensing the RPM of one or more of the rear wheels. As above, the speed of vehicle 12 is calculated or determined from the rotational speed of the wheel. The remaining electrical components of system 10 are configured to operate with the vehicle 12 and warning lights 18 as described above to provide a visual warning to persons driving vehicles behind vehicle 12 that vehicle 12 is slowing down, moving slow or preparing to stop.

Additional improvements to the system 10 of the present invention include the use of removable lens 58 configured to reduce the light intensity from the warning lights 18. With the ability to remove lens 58, the operator of vehicle 12 can change the light intensity (to full yellow light) and, as a result, the intensity of the warning lights 18. For instance, in some circumstances of inclement weather (i.e., fog, dust storm or heavy rain) the subdued lens is removed to obtain full intensity. Preferably, during removal of the lens, a reminder alarm (i.e., buzzer or flashing light) is activated and remains activated until the subdued lens is replaced. In a preferred embodiment, the selection of the color of lens 58 can be controlled by the driver from a switch on the dash or other driver compartment area. Alternatively, lens 58 can be suitable for manual replacement, such as having a threaded portion or being removably attached by a screw, bolt or other connector. Yet another alternative is to have lens 58 attached in a manner that allows the driver to flip or otherwise rotate lens 58 to expose a different (i.e., lighter colored) lens or to expose the lamp inside warning lights 18. One additional benefit of such an optional feature is that if the vehicle 12 became disabled, the driver could manually or electronically change the lens 58 so that the lights 18 flash a colored signal that would be designated as an emergency flash.

Another alternative embodiment includes the capability to flash warning lights 18 at different rates of flashing depending on the change in speed of vehicle 12. Such a system is disclosed in U.S. Pat. No. 3,593,278 to Bower. The benefit of such an addition is that the driver of the trailing vehicle will be able to tell from the frequency of flashes whether the vehicle is slowing down rapidly or in a slower, more controlled fashion. For instance, the lights 18 could flash at a slow frequency as the vehicle begins the slowdown and at a faster frequency as the vehicle approaches a stopped condition. As vehicle 12 begins accelerating to the driving speed, the lights could flash frequently and then slow down as the vehicle 12 approaches the base speed limit, at which time the flashing would cease. If multiple colored lights are used (i.e., red and yellow) they could work in conjunction with the red light, for example, only flashing at the lower vehicle speeds.

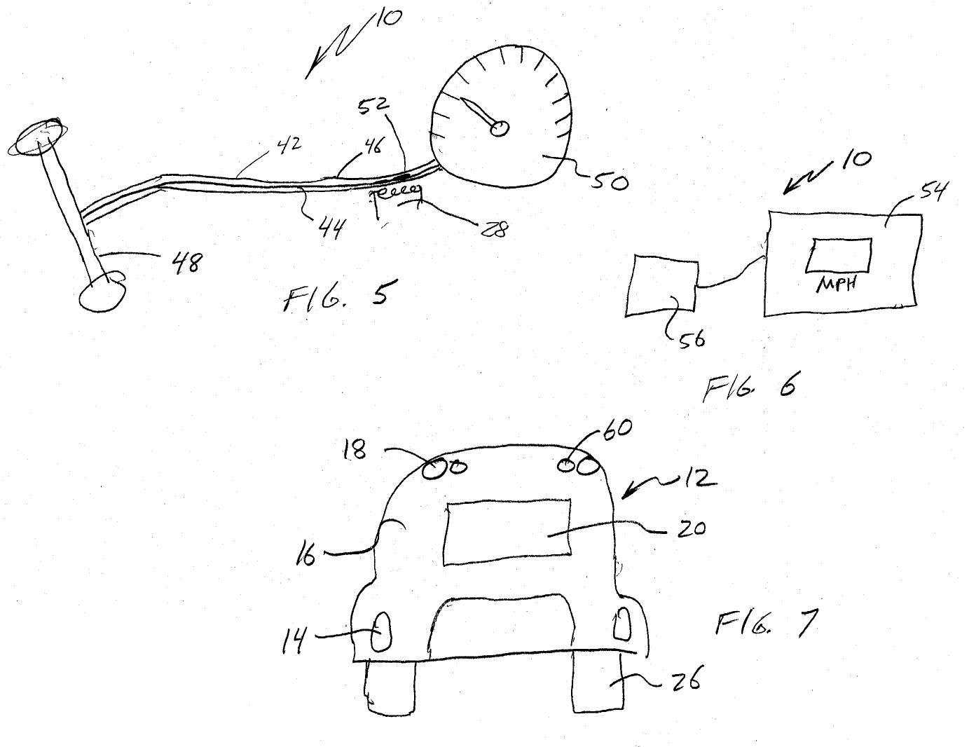

Another possible additional capability is the inclusion of one or more stop lights 60 positioned next to warning lights 18, as shown in FIG. 7 (which shows one light next to each of the two warning lights). Alternatively, a single centrally positioned stop light 60 can be used. While vehicle 12 drives down the road, both warning lights 18 and stop lights 60 are off. As the vehicle slows down, warning lights 18 will be activated as described above (with or without the flashing and variable frequency flashing) until vehicle 12 comes to a complete stop or slows down below a designated near-stop speed (such as 5 mph). When the vehicle 12 stops or reduces its speed below the designated near-stop speed, stop lights 60 will be activated to warn trailing vehicles of the complete or near stopped condition. Warning red stop lights 60 are to remain on until the sensor senses motion of the vehicle or, if the near-stop embodiment is used, when the vehicle speed exceeds the designated near-stop speed.

In yet another alternative embodiment of the speed sensor 22, shown in FIG. 8, for use with the rear light warning system 10 of the present invention utilizes a wavelength transmitter 62 and receiver 64 that work in conjunction to determine the speed of the vehicle by reflecting a wavelength, shown as 65, off of the pavement, ground or other driving surface 66. The wavelength transmitter 62 and receiver 64 can utilize infrared, sound or other like signals 65 by having the transmitter 62 transmit the signal 65 so that it reflects off the pavement or ground 66 and is received by receiver 64. The sensor 22 is connected to the integrated circuit 34, which is modified to include the capability to calculate the speed of the vehicle 12 relative to the driving surface 66 by measuring the amount of time necessary for wavelength 65 to travel from transmitter 62 to receiver 64. The remaining electrical components of system 10 are configured to operate with the vehicle 12 and warning lights 18 as described above to provide a visual warning to persons driving vehicles behind vehicle 12 that vehicle 12 is slowing down, moving slow or preparing to stop. As above, circuit 34 should be operatively connected to the ignition switch 40 so that it will only operate when the key is turned to the “run” position.

By utilizing a vehicle speed sensor device 22, as described above, the system 10 of the present invention avoids the problems associated with reliance on the use of the pressure or movement of the brake or accelerator pedals as a means to determine if the vehicle is slowing down, moving slow or accelerating. The vehicle speed sensor 22 allows the driver of the trailing vehicle to know the true relative speed of the leading vehicle. Use of such system 10 will reduce the likelihood of rear end collisions resulting from the driver of the trailing vehicle not seeing or comprehending quickly enough that the vehicle in front of him or her is not moving as fast as it was or is moving slower than the standard traffic speed as a result of the leading vehicle driver's need to slow down due to weather, road, traffic or other conditions or due to the need to slow down for a turn or other driving maneuver.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are components described herein that can be replaced with equivalent functioning components to accomplish the objectives of the present invention.

What is claimed is:

1. A vehicle rear light warning system adapted for use with a vehicle, comprising:
one or more warning lights fixedly attached to a rear side of the vehicle, said one or more warning lights configured to be generally rearwardly illuminating;
sensor means attached to the vehicle for sensing the speed of the vehicle, said sensor means configured to be independent of the vehicle's brake and acceleration pedals; and
an integrated circuit for calculating the speed of the vehicle relative to a predetermined base speed level and for activating said one or more warning lights when the speed of the vehicle is below said predetermined base speed level.

2. The vehicle rear light warning system according to claim 1, wherein said system is operatively connected to a battery on the vehicle.

3. The vehicle rear light warning system according to claim 1, wherein said system is electrically connected to an ignition switch on the vehicle, said system configured to be activated when said ignition switch is in an on or run condition.

4. The vehicle rear light warning system according to claim 1 further comprising a voltage comparator operatively connected to said sensor means and said integrated circuit.

5. The vehicle rear light warning system according to claim 1, wherein said sensor means measures the speed of the vehicle by sensing the rotation of a wheel on the vehicle.

6. The vehicle rear light warning system according to claim 5, wherein said sensor means comprises a magnet fixedly attached to said wheel and a magnetic sensor coil attached to said vehicle, said magnet and said magnetic sensor coil operatively displaced so as to generate an electrical signal suitable for said integrated circuit to determine the speed of the vehicle relative to said predetermined base speed level.

7. The vehicle rear light warning system according to claim 5, wherein said sensor means comprises a magnetic sensor coil fixedly attached to said wheel and a magnet attached to said vehicle, said magnet and said magnetic sensor coil operatively displaced so as to generate an electrical signal suitable for said integrated circuit to determine the speed of the vehicle relative to said predetermined base speed level.

8. The vehicle rear light warning system according to claim 1, wherein said sensor means measures the speed of the vehicle by sensing the rotational speed of a rotating inner cable of a speedometer cable in the vehicle.

9. The vehicle rear light warning system according to claim 8, wherein said sensor means further comprises one or more magnetic strips attached to said inner cable and a magnetic sensor coil operatively displaced from said speedometer cable so as to generate an electrical signal suitable for said integrated circuit to determine the speed of the vehicle relative to said predetermined base speed level.

10. The vehicle rear light warning system according to claim 1, wherein said sensor means is operatively connected to an electronic speedometer in the vehicle to generate an electrical signal relative to the speed of the vehicle.

11. The vehicle rear light warning system according to claim 10, wherein said sensor means further comprises an electronic circuit to control said sensor means, said electronic circuit operatively connected to an ignition switch on the vehicle, said system configured to be activated when said ignition switch is in an on or run condition.

12. The vehicle rear light warning system according to claim 1, wherein said one or more warning lights have a removable lens.

13. The vehicle rear light warning system according to claim 12, wherein said removable lens is hingedly attached to said warning lights.

14. The vehicle rear light warning system according to claim 1 further comprising one or more stop lights fixedly attached to said rear side of the vehicle, said stop lights configured to be generally rearwardly illuminating, said stop lights operatively connected to said integrated circuit so as to activate said stop lights when the vehicle stops moving or the vehicle speed is below a designated near-stop speed.

15. The vehicle rear light warning system according to claim 14, wherein one of said stop lights is located next to one of said warning lights.

16. The vehicle rear light warning system according to claim 1, wherein said sensor means measures the speed of the vehicle by utilizing a wavelength transmitter in cooperation with a receiver to reflect a wavelength off of a driving surface.

17. A vehicle rear light warning system adapted for use with a vehicle, comprising:
one or more warning lights fixedly attached to a rear side of the vehicle, said one or more warning lights configured to be generally rearwardly illuminating;
one or more stop lights fixedly attached to said rear side of the vehicle, said stop lights configured to be generally rearwardly illuminating;
sensor means attached to the vehicle for sensing the speed of the vehicle, said sensor means configured to be independent of the vehicle's brake and acceleration pedals; and
an integrated circuit for calculating the speed of the vehicle relative to a predetermined base speed level and for activating said one or more warning lights when the speed of the vehicle is below said predetermined base speed level and for activating said stop lights when the vehicle stops moving, said integrated circuit operatively connected to a battery on the vehicle, said system electrically connected to an ignition switch on the vehicle and configured to be activated when said ignition switch is in an on or run condition.

18. The vehicle rear light warning system according to claim 17, wherein said sensor means measures the speed of the vehicle by sensing the rotation of a wheel on the vehicle, said sensor means comprising a magnet fixedly attached to said wheel and a magnetic sensor coil attached to said vehicle, said magnet and said magnetic sensor coil operatively displaced so as to generate an electrical signal suitable for said integrated circuit to determine the speed of the vehicle relative to said predetermined base speed level.

19. The vehicle rear light warning system according to claim 17, wherein said sensor means measures the speed of the vehicle by sensing the rotational speed of a rotating inner cable of a speedometer cable in the vehicle, said sensor means further comprising one or more magnetic strips attached to said inner cable and a magnetic sensor coil operatively displaced from said speedometer cable so as to generate an electrical signal suitable for said integrated circuit to determine the speed of the vehicle relative to said predetermined base speed level.

20. The vehicle rear light warning system according to claim 17, wherein said sensor means is operatively connected to an electronic speedometer in the vehicle so as to generate an electrical signal relative to the speed of the vehicle, said sensor means further comprising an electronic circuit to control said sensor means, said electronic circuit operatively connected to an ignition switch on the vehicle, said system configured to be activated when said ignition switch is in an on or run condition.
